(19) United States
(12) Patent Application Publication
(10) Pub. No.: US 2024/0411034 A1
(43) Pub. Date: Dec. 12, 2024

(54) CAVITY IONIZATION CHAMBER FOR MEASURING DOSE RATE AT PROTECTION-LEVEL

(71) Applicant: National Institute of Metrology, China, Beijing (CN)

(72) Inventors: Dehong Li, Beijing (CN); Jianbo Cheng, Beijing (CN); Jianwei Huang, Beijing (CN); Chuanfeng Liu, Beijing (CN); Jintie Wu, Beijing (CN); Yue Li, Beijing (CN); Dongyang Li, Beijing (CN); Bo Liu, Beijing (CN)

(21) Appl. No.: 18/731,788

(22) Filed: Jun. 3, 2024

(30) Foreign Application Priority Data
Jun. 12, 2023 (CN) 202310690741.6

(51) Int. Cl. G01T 1/185

(52) U.S. Cl. CPC G01T 1/185

(57) ABSTRACT

Provided is a cavity ionization chamber for measuring dose rate at a protection level. In the cavity ionization chamber, an ionization chamber sensitive volume includes a high-voltage electrode, and a collecting electrode, and an ionization chamber stem is connected to the ionization chamber sensitive volume and a first TNC interface. The ionization chamber stem is directly connected to an inner wall of the high-voltage electrode through a socket connector and is flush with a tangent plane of a spherical surface formed by the inner wall of the high-voltage electrode at an intersection of a straight line where the ionization chamber stem is located and the spherical surface. The first TNC interface is connected to one end of a guarding electrode through an inner shielding layer of a coax cable double shielded, and the other end of the guarding electrode penetrates into the ionization chamber sensitive volume.

### CROSS-REFERENCE TO RELATED APPLICATION

This patent application claims the benefit and priority of Chinese Patent Application No. 2023106907416 filed with the China National Intellectual Property Administration on Jun. 12, 2023, the disclosure of which is incorporated by reference herein in its entirety as part of the present application.

### TECHNICAL FIELD

The present disclosure relates to the technical field of ionization chambers, and in particular to a cavity ionization chamber for measuring dose rate at protection-level.

### BACKGROUND

Ionization chamber is important equipment for detecting ionizing radiation, which is often used as a standard measuring instrument for detecting ionizing radiation dose. There are a few researches on large-volume ionization chambers for protection level in China. In 2019, China Institute of Atomic Energy developed a graphite cavity ionization chamber for measuring air kerma of Cs-137γ radiation field. The developed ionization chamber has a volume of 300 cm³, a leakage current of more than 15 fA, a short-term repeatability of 0.025% and an angle response of 0.274%. However, there is little research on the ionization chamber with a volume of more than 1L in China, and 32002 (1L) ionization chamber produced by German PTW company is usually used as a standard ionization chamber for transferring to measure dose rate at the protection level, while there are basically no related instruments with a capacity more than 1 L in China.

Ideally, a wall material of the ionization chamber should be air equivalent material (such as graphite, polyoxymethylene, etc.). In domestic prior art, researchers mainly focus on the development of a small-volume graphite cavity ionization chamber. The graphite material for a large-volume ionization chamber is an organic air equivalent material, which is brittle and characterized by fracture toughness, and thus the strength of the graphite material is difficult to support weight of the large-volume ionization chamber and does not have the ability to resist general impact.

For the large-volume ionization chambers, as the polyoxymethylene (POM) need to be used as the wall material of the high-voltage electrode chamber, the conductivity of the inner wall, combination of the two hemispheres and the wide energy response of the high-voltage electrode have become technical difficulties.

Furthermore, it is difficult to solve the electric leakage problem and energy response index of the ionization chamber at present in China. The inner wall of the high-voltage electrode of the same type of PTW ionization chamber is bonded to the inner wall of the chamber by wires, which has high technical difficulty and will have a certain impact on the uniformity and symmetry of the electric field.

Therefore, there is a need to design a cavity ionization chamber for protection level, which can achieve the localization of measuring instruments, and the cavity ionization chamber is suitable for measuring dissemination of value of quantity of low- and medium-dose rate in wide-energy (48 keV−1.25 MeV) X/γ ray protection level.

### SUMMARY

An objective of the present disclosure is to overcome the shortcomings in the prior art, and provides a cavity ionization chamber for protection level, which can achieve the localization of measuring instruments and the master of the core technology, and the cavity ionization chamber is suitable for measuring dissemination of value of quantity of low- and medium-dose rate in wide-energy (48 keV−1.25 MeV) X/γ ray protection level.

In order to achieve the objective, a cavity ionization chamber for protection level is provided according to the present disclosure, including an ionization chamber sensitive volume, an ionization chamber stem, and a first Thread Neill-Concelman (TNC) interface. The ionization chamber sensitive volume includes a high-voltage electrode, and a collecting electrode. The ionization chamber stem is connected to the ionization chamber sensitive volume and the first TNC interface. The ionization chamber stem is directly connected to an inner wall of the high-voltage electrode through a socket connector and is flush with a tangent plane of a spherical surface formed by the inner wall of the high-voltage electrode at an intersection of a straight line where the ionization chamber stem is located and the spherical surface. The first TNC interface is connected to one end of a guarding electrode through an inner shielding layer of a coax cable double shielded, and the other end of the guarding electrode penetrates into the ionization chamber sensitive volume to isolate the high-voltage electrode from the collecting electrode.

The high-voltage electrode is composed of an upper hemisphere and a lower hemisphere, and the upper hemisphere and the lower hemisphere are in contact with each other and connected through a R-shaped structure.

The inner wall of the high-voltage electrode is provided with a colloidal graphite conductive layer.

An outer wall of the high-voltage electrode is made of polyoxymethylene as air equivalent material.

One end of the socket connector is connected to the high-voltage electrode, and the other end of the socket connector is connected to the ionization chamber stem.

The collecting electrode is hollow-core and made of polymethyl-methacrylate, and a surface of the collecting electrode is provided with a colloidal graphite conductive layer.

The ionization chamber stem is made of dural.

One end of the ionization chamber stem is connected to a second TCN interface through a coax cable double shielded, and the other end of the ionization chamber stem is connected to the high-voltage electrode, the collecting electrode and the guarding electrode through the socket connector.

The collecting electrode is provided with polyoxymethylene supporting stems at both sides thereof, and surfaces of the supporting stems are provided with aluminum foil conductive layers, and the supporting stems are separated from the high-voltage electrode by insulating materials.

Compared with the prior art, POM material is used as an outer all of a high-voltage electrode of an ionization chamber, and a colloidal graphite conductive layer is uniformly sprayed on an inner wall of the high-voltage electrode, so as to solve the problem of low strength of the graphite material. The binding strength of the two hemispheres of POM is increased by using a R-shaped structure for uniform force bearing, and the conduction problem between upper and lower hemispheres of the ionization chamber is solved through the connection of contact surfaces. A collecting electrode of the ionization chamber employs the combination of a stem and a sphere to make an electric field inside the ionization chamber uniform, and incomplete air equivalence (which means that air equivalence cannot be achieved) of an outer wall of a high-voltage electrode is balanced through the cooperation of aluminum with high atomic number adhered on the stem and a graphite conductive layer on the sphere, which improves the energy response of a low-energy range of the ionization chamber. The ionization chamber stem is directly connected to an inner wall of the high-voltage electrode through the socket connector and is flush with a crown face of the inner wall of the high-voltage electrode, thus bypassing the challenge of directly bonding a wire with the inner wall of the high-voltage electrode and the influence on an electric field.

### BRIEF DESCRIPTION OF THE DRAWINGS

FIG. 1 is a schematic diagram showing structural composition of an ionization chamber and the connection of various parts;

FIG. 2 is a schematic diagram of a structure according to the present disclosure;

FIG. 3 is a graph showing tested volt-ampere characteristics according to the present disclosure;

FIG. 4 is a graph showing tested energy-response of an ionization chamber according to the present disclosure.

In the drawings:

1-high-voltage electrode; 2-collecting electrode; 4-socket connector; 5-guarding electrode; 6-first TNC interface; 7-ionization chamber stem; 8-second TNC interface.

### DETAILED DESCRIPTION OF THE EMBODIMENTS

The present disclosure is further described below with reference to the accompanying drawings.

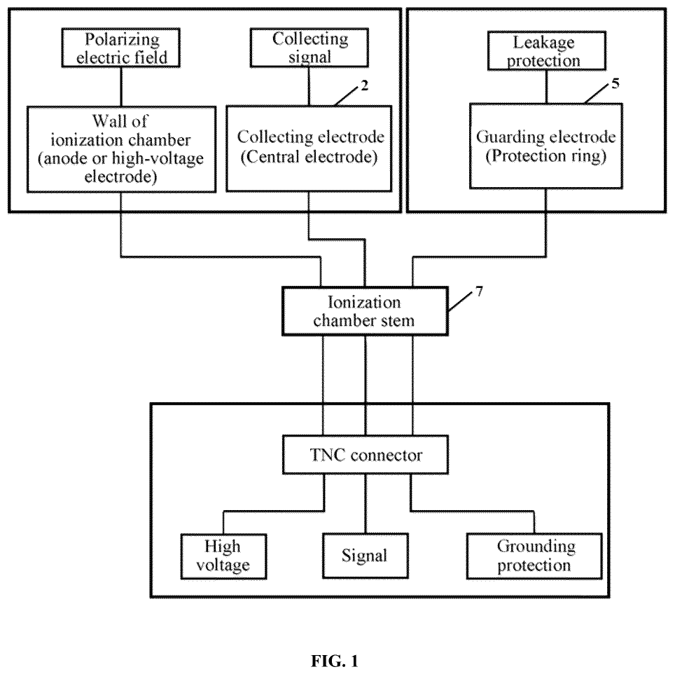

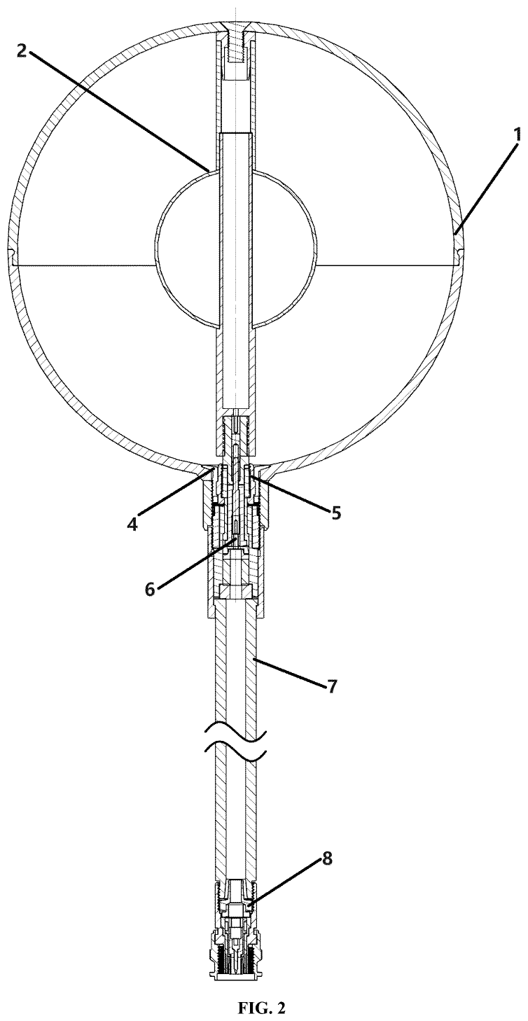

Referring to FIG. 1 to FIG. 4, a cavity ionization chamber for protection level is provided.

The cavity ionization chamber includes an ionization chamber sensitive volume, an ionization chamber stem 7, and a first TNC interface 6. The ionization chamber sensitive volume includes a high-voltage electrode 1, and a collecting electrode 2. The ionization chamber stem 7 is connected to the ionization chamber sensitive volume and the first TNC interface 6. The ionization chamber stem 7 is directly connected to an inner wall of the high-voltage electrode 1 through a socket connector 4 and is flush with a crown face of the inner wall of the high-voltage electrode 1. The first TNC interface 6 is connected to one end of a guarding electrode 5 through an inner shielding layer of a coax cable double shielded, and the other end of the guarding electrode 5 penetrates into the ionization chamber sensitive volume to isolate the high-voltage electrode 1 from the collecting electrode 2.

The high-voltage electrode 1 is composed of an upper hemisphere and a lower hemisphere, and the upper hemisphere and the lower hemisphere are in contact with each other and connected through a R-shaped structure.

The inner wall of the high-voltage electrode 1 is provided with a colloidal graphite conductive layer.

An outer wall of the high-voltage electrode 1 is made of air equivalent material, namely polyoxymethylene.

One end of the socket connector 4 is connected to the high-voltage electrode 1, and the other end of the socket connector 4 is connected to the ionization chamber stem 7.

The collecting electrode 2 is hollow-core and made of polymethyl methacrylate, and is provided with a colloidal graphite conductive layer on a surface thereof.

The ionization chamber stem 7 is made of dural.

One end of the ionization chamber stem 7 is connected to a second TCN interface 8 through a coax cable double shielded, and the other end of the ionization chamber stem 7 is connected to the high-voltage electrode 1, the collecting electrode 2 and the guarding electrode 5 through the socket connector 4.

The collecting electrode 2 is provided with polyoxymethylene supporting stems at its both sides, and surfaces of the supporting stems are provided with aluminum foil conductive layers, and the supporting stems are separated from the high-voltage electrode 1 by insulating materials.

The operation principle is as follows:

The outer wall of the high-voltage electrode 1 is made of air equivalent material, namely polyoxymethylene (POM), and the inner wall of the high-voltage electrode is sprayed with colloidal graphite. Upward spraying is adopted during spraying process, thus reducing the influence of larger particles in the atomized colloidal graphite. By means of spraying at low intensity and high frequency the colloidal graphite is uniformly deposited on an inner surface of a wall of the ionization chamber to form a graphite conductive thin layer, which has a resistance value at the order of about 100 ohms.

The upper hemisphere and the lower hemisphere of the high-voltage electrode 1 are fastened using a R-shaped structure, conductive layers are in contact and conduction with each other through contact surfaces of the two hemispheres, and POM special glue is used for bonding outer walls of the two hemispheres to increase the strength of the combination of the two hemispheres, thereby bypassing the challenge of bonding wires on inner walls of the two hemispheres for conduction in PTW and the challenge of fastening the upper and lower hemispheres through multiple small metal rings in PTW.

A wall of the high-voltage electrode 1 is in conduction with the ionization chamber stem 7. Specifically, one end of the socket connector 4 is in contact with a bottom end of the wall of the high-voltage electrode 1 of the ionization chamber, and the other end of the socket connector 4 is connected to the ionization chamber stem 7, thereby avoiding the instability and difficulty of bonding the wire to the inner wall of the high-voltage electrode of the ionization chamber. Further, the socket connector 4 is in direct contact with the graphite conductive layer and flush with a crown face of the inner wall of the high-voltage electrode 1, thus avoiding the influence of bonding on the uniformity and symmetry of the electric field.

A sphere of the collecting electrode 2 is hollow-core and made of polymethyl methacrylate (PMMA), and the incomplete air equivalence of a wall material of the ionization chamber is balanced through aluminum with higher atomic number and graphite on an inner wall of the sphere, thereby improving the energy response of the low-energy range of the ionization chamber, and achieving a wide energy detection range.

An external cable is connected to a second TNC interface 8 of the ionization chamber to apply a working voltage. When x/γ rays irradiate the ionization chamber, an ionization current is generated in an electric field formed by high-voltage electrode 1 and the collecting electrode 2, and then is led out to a dosimeter through collecting electrode 2 for reading.

According to the present disclosure, the structural design of an ionization chamber with capacity of 1L is achieved, with main performance index as follows:

| | | Indicators achieved by | |
|---|---|---|---|
| | | the ionization chamber | |
| | | for measuring dose rate | |
| | | at a protection-level | |
| | PTW 32002(1 L) | with capacity of 1 L | |
| Key | Technical indicators | provided by the | |
| parameter | of ionization chamber | present disclosure | Notes |

| | | | | |
|---|---|---|---|---|
| Nominal | 1000 | cm³ | 1000 | cm³ |
| sensitive | | | | |
| volume | | | | |

| | | |
|---|---|---|
| Annual | ≤±1% | ≤±0.5% |

stability

| | | |
|---|---|---|
| Energy | ≤±4% (40 | ≤±4% (39 |
| response | keV~Co-60, | keV~Co-60, |
| | normalized to Co-60) | normalized to Co-60) |
| Angle | Rotating around the | Rotating around the |
| response | axis of ionization | axis of ionization |
| | chamber by ≤±0.5% | chamber by ≤±0.5% |

| | | | | |
|---|---|---|---|---|
| Electric | ≤±10 | fA | ≤±10 | fA |
| leakage | | | | |

| | | |
|---|---|---|
| Polarization | ±200 V-±500 V | ±300 V-±800 V |

voltage

| | | |
|---|---|---|
| Ionization | 3.1 μGy/h-0.42 Gy/h | 3.4 μGy/h-1.5 Gy/h |

chamber
range
collection
efficiency ≥99%)

| | | |
|---|---|---|
| Polarization effect | ≤±1% | ≤±0.5% |

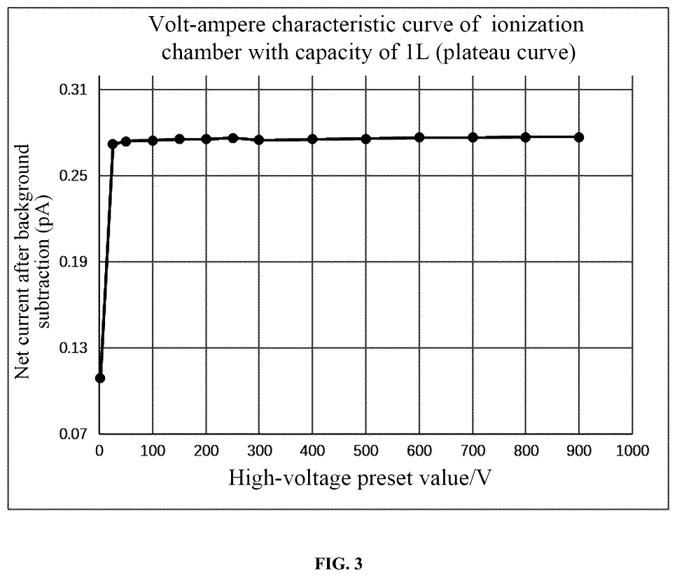

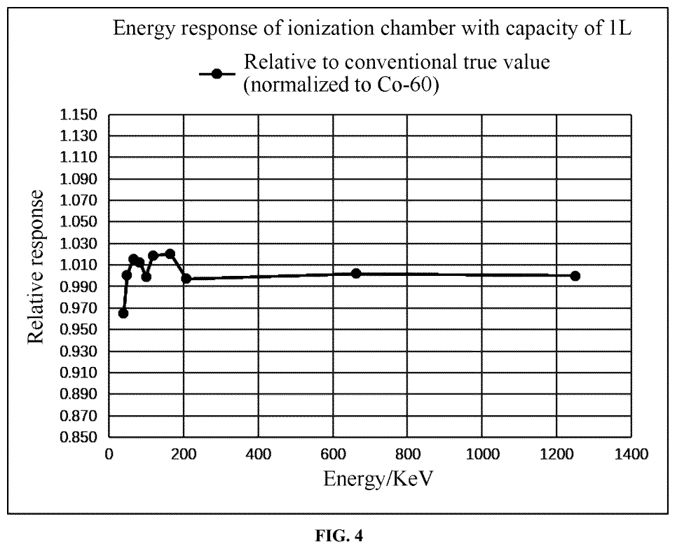

A volt-ampere characteristic curve (plateau curve) and an energy response curve of the ionization chamber tested during operation are shown in FIG. 3 and FIG. 4, and key performance indicators have reached or exceeded the level of the same type of ionization chamber of PTW.

The embodiments of the present disclosure have been described above, but the scope of the present disclosure is not limited thereto. Various changes can be made and implemented by the user without departing from the scope of the gist of the present disclosure, which are all included in the scope of protection of this patent.

What is claimed is:

1. A cavity ionization chamber for measuring dose rate at protection-level, comprising an ionization chamber sensitive volume, an ionization chamber stem (7), and a first Thread Neill-Concelman (TNC) interface (6), wherein the ionization chamber sensitive volume comprises a high-voltage electrode (1), and a collecting electrode (2); the ionization chamber stem (7) is connected to the ionization chamber sensitive volume and the first TNC interface (6); the ionization chamber stem (7) is directly connected to an inner wall of the high-voltage electrode (1) through a socket connector (4) and is flush with a tangent plane of a spherical surface formed by the inner wall of the high-voltage electrode (1) at an intersection of a straight line where the ionization chamber stem (7) is located and the spherical surface; the first TNC interface (6) is connected to one end of a guarding electrode (5) through an inner shielding layer of a coax cable double shielded, and another end of the guarding electrode (5) penetrates into the ionization chamber sensitive volume to isolate the high-voltage electrode (1) from the collecting electrode (2).

2. The cavity ionization chamber according to claim 1, wherein the high-voltage electrode (1) is composed of an upper hemisphere and a lower hemisphere, and the upper hemisphere and the lower hemisphere are in contact with each other and connected through a R-shaped structure.

3. The cavity ionization chamber according to claim 1, wherein the inner wall of the high-voltage electrode (1) is provided with a colloidal graphite conductive layer.

4. The cavity ionization chamber according to claim 1, wherein an outer wall of the high-voltage electrode (1) is made of polyoxymethylene as air equivalent material.

5. The cavity ionization chamber according to claim 1, wherein one end of the socket connector (4) is connected to the high-voltage electrode (1), and another end of the socket connector (4) is connected to the ionization chamber stem (7).

6. The cavity ionization chamber according to claim 1, wherein the collecting electrode (2) is hollow-core and made of polymethyl methacrylate, and a surface of the collecting electrode (2) is provided with a colloidal graphite conductive layer.

7. The cavity ionization chamber according to claim 1, wherein the ionization chamber stem (7) is made of dural.

8. The cavity ionization chamber according to claim 1, wherein one end of the ionization chamber stem (7) is connected to a second TCN interface (8) through a coax cable double shielded, and another end of the ionization chamber stem (7) is connected to the high-voltage electrode (1), the collecting electrode (2) and the guarding electrode (5) through the socket connector (4).

9. The cavity ionization chamber according to claim 1, wherein the collecting electrode (2) is provided with polyoxymethylene supporting stems at both sides thereof, and surfaces of the supporting stems are provided with aluminum foil conductive layers, and the supporting stems are separated from the high-voltage electrode (1) by insulating materials.
